(19) United States
(12) Patent Application Publication
(10) Pub. No.: US 2012/0171098 A1
(43) Pub. Date: Jul. 5, 2012

(54) METHOD OF CONSOLIDATING ULTRAFINE METAL CARBIDE AND METAL BORIDE PARTICLES AND PRODUCTS MADE THEREFROM

(75) Inventors: Cheng-Hung Hung, Wexford, PA (US); Noel R. Vanier, Wexford, PA (US)

(73) Assignee: PPG INDUSTRIES OHIO, INC, Cleveland, OH (US)

(21) Appl. No.: 12/017,585

(22) Filed: Jan. 22, 2008

(51) Int. Cl. C01B 35/04; C01B 31/30; C04B 35/64; B82Y 40/00

(52) U.S. Cl. 423/289; 264/666; 264/667; 423/439; 977/900

(57) ABSTRACT

Ultrafine metal carbide or metal boride particles are consolidated by a method including sintering at intermediate pressures. A green body comprising the ultrafine metal carbide or metal boride particles may be preheated under vacuum and then pressurized to the intermediate sintering pressure. After sintering, the article may be densified at an intermediate temperature below the sintering temperature, and at an elevated pressure above the intermediate sintering temperature. The resultant consolidated metal carbide or metal boride article may then be cooled and used for such applications as armor panels, abrasion resistant nozzles, and the like.

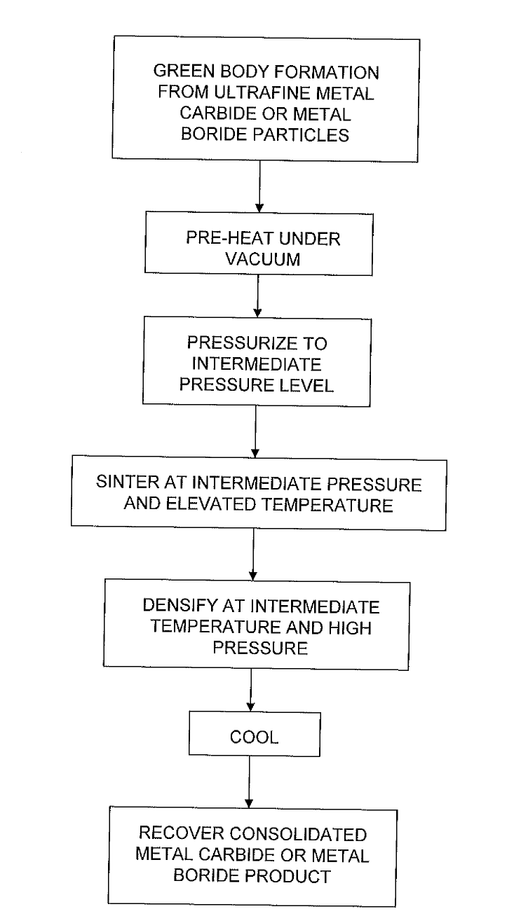

### GOVERNMENT CONTRACT

This invention was made with United States government support under Contract Number W911NF-05-9-0001 awarded by DARPA. The United States government may have certain rights in this invention.

### FIELD OF THE INVENTION

The present invention relates to consolidation of metal carbide and metal boride particles, and more particularly relates to a method of consolidating ultrafine metal carbide and metal boride particles which includes the use of intermediate sintering pressures. The invention also relates to consolidated metal carbide and metal boride products made by such a method.

### BACKGROUND INFORMATION

Boron carbide particles having particle sizes of greater than 0.2 micron have been produced by solid phase synthesis using B₂O₃ and carbon as starting reactant materials and subsequent milling. Such particles may be sintered to form various products such as armor panels and abrasion resistant nozzles.

Conventional boron carbide sintering processes have been performed at atmospheric and sub-atmospheric pressures. After such low pressure sintering, hot isostatic pressing (HIPing) at high pressures is often utilized to produce the final densified sintered product. A problem associated with conventional boron carbide sintering technique is the tendency for boron to vaporize out of the green body once it is heated, which causes unwanted particle coarsening to occur and unwanted formation of free carbon or graphite. Furthermore, boron oxide impurities create boron oxide liquid and vapor when the green body is heated, resulting in reduced densification in the sintered product. Boron vaporization, particle coarsening and reduced densification due to vaporization of boron oxide impurities become more severe as the size of the boron oxide particles is decreased, particularly for particle sizes less than 100 or 200 nanometers.

### SUMMARY OF THE INVENTION

In certain respects, the present invention is directed to providing a method of consolidating ultrafine metal carbide or metal boride particles comprising the steps of: providing a green body comprising the ultrafine metal carbide or metal boride particles; and sintering the green body at a sintering temperature and at an intermediate sintering pressure of from greater than 1 atmosphere to less than 100 atmospheres.

In other respects, the present invention is directed to providing a consolidated metal carbide or metal boride article produced by the foregoing method.

### BRIEF DESCRIPTION OF THE DRAWINGS

The FIGURE is a flowchart depicting the steps of certain methods of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

Certain embodiments of the present invention are directed to methods for consolidating ultrafine metal carbide or metal boride particles. Examples of ultrafine metal carbides that may be used in the process include boron carbides such as B₄C, B₁₃C₂, B_{B}C, B₁₀C, B₂₅C. Other ultrafine metal carbides that may be produced in accordance with the present invention include tungsten carbide, titanium carbide, silicon carbide, aluminum carbide, iron carbide, zirconium carbide, magnesium aluminum carbide, hafnium carbide and the like. Examples of ultrafine metal borides include borides of refractory metals such as Ti, V, Cr, Zr, Nb, Mo, Hf, Ta and W.

As used herein, the term “ultrafine particles” refers to metal carbide or metal boride particles having a B.E.T. specific surface area of at least 5 square meters per gram, such as 20 to 200 square meters per gram, or, in some cases, 30 to 100 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the ultrafine particles made in accordance with the present invention have a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:

Diameter (nanometers)=6000/[BET(m²/g)*ρ(grams/cm³)]

In certain embodiments, the ultrafine metal carbide or metal boride particles have an average particle size of no more than 200 or 100 nanometers, in some cases, no more than 50 nanometers or, in yet other cases, no more than 30 or 40 nanometers. As used herein, the term “average particle size” refers to a particle size as determined by visually examining a micrograph of a transmission electron microscopy (“TEM”) image, measuring the diameter of the particles in the image, and calculating the average particle size of the measured particles based on magnification of the TEM image. One of ordinary skill in the art will understand how to prepare such a TEM image and determine the average particle size based on the magnification. The size of a particle refers to the smallest diameter sphere that will completely enclose the individual particle.

In accordance with certain embodiments of the invention, the ultrafine metal carbide or metal boride particles may comprise sintering aids or dopants. Sintering aids or dopants that may be incorporated in the ultrafine metal carbide or metal boride particles include Al, Ti, W, Zr, Mg, N, Fe, Na, Ca, Si, Y, La, Hf, Ta, Mo, Ni, Co, V, Nb, Ce, Mn, Li, Nd and the like. Such sintering aids and dopants are uniformly distributed on a submicron or nano scale, which provides uniform dispersion when the ultrafine metal carbide or metal boride particles are subsequently sintered. The sintering aids or dopants are typically present in an amount up to about 10 atomic percent, for example, from about 0.01 to about 2 or 5 atomic percent.

U.S. patent application Ser. Nos. 11/468,424, 11/613, 551 and 11/873,712, which are incorporated herein by reference, disclose methods and apparatus for producing ultrafine metal carbide particles that may be consolidated in accordance with certain embodiments of the present invention.

The FIGURE is a flowchart schematically illustrating a method in accordance with certain embodiments of the present invention. In the first step, a green body is formed from the ultrafine metal carbide or metal boride particles. Standard green body formation techniques such as uniaxially pressing, isostatic pressing, tape casting, extruding, or slip casting may be used. A binder in amounts up to 20 weight percent, and typically from 1 to 5 weight percent, may be added to the ultrafine metal carbide or metal boride particles in order to aid in green body strength of the compressed powders. Examples of some suitable types of binders include poly(vinylalcohol), poly(ethylene glycol), poly(ethylene), stearic acid and the like.

The next step illustrated in the FIGURE is preheating of the green body under vacuum. Such preheating at sub-atmospheric pressures removes unwanted boron oxide from the green body which could otherwise adversely affect the density or other properties of the sintered product. Preheating to temperatures of from 1,000 to 1,400° C. may be used, for example, about 1,200° C. The level of vacuum during the preheating steps is typically less than 0.2 atmosphere, for example, from about 0.1 to about 0.001 atmosphere. The preheating step may be performed in a suitable vessel, such as a HIP chamber, or other vacuum rated oven, or the like.

After the preheating step, the green body is pressurized to an intermediate pressure level which reduces or eliminates volatilization of the metal component of the metal carbide the boron component of the metal boride when the green body is heated to sintering temperatures. The intermediate pressure level may range from greater than 1 atmosphere to less than 100 atmospheres, for example, from 2 to 20 atmospheres. In some cases, the intermediate pressure level may be from 5 to 10 atmospheres. The intermediate pressurization step may be performed in the presence of an inert gas such as He, Ar, H₂ or the like. The intermediate pressurization step is typically performed at a temperature of from 1,400 to 2,300° C., for example, from 1,800 to 2,300° C.

After the green body has been pressurized to the intermediate pressure level, the temperature of the green body is elevated to a sintering temperature. Typical sintering temperatures for boron carbide may be from 2,000 to 2,500° C., in some cases, 2,300° C. The sintering temperatures for other metal carbides or metal borides may be varied. The sintering temperature may be reached by ramping the temperature of the green body at a typical rate of from 2 to 200° C. per minute. Once the desired sintering temperature is reached, the body may be held for a desired amount of time, for example, from 1 minute to 2 hours, in some cases, about 5 minutes.

In the embodiment shown in the FIGURE, after the sintering step, the body may be cooled to an intermediate temperature under increased pressure in order to densify the body. Intermediate densification temperatures may be from 1,500 to 2,100° C., in some cases, about 2,000° C. Densification pressures from about 500 to about 7,000 atmospheres may be used, in some cases, from about 1,000 to about 4,000 atmospheres. The body may be held at the densification temperature and pressure for 10 minutes to 4 hours, in some cases, about 1 hour.

After the densification step, the sintered body is allowed to cool, for example, at rates of from about 2 to about 100° C. per minute. In some cases, cooling is achieved by removing heating power from the vessel in which the sintered body is contained, and allowing the vessel to cool down to ambient room temperature.

The cooled sintered body is then recovered to provide a sintered metal carbide or metal boride product which exhibits significantly reduced particle coarsening and high densities.

The following example illustrates aspects of the present invention, and is not intended to limit the scope of the invention.

### EXAMPLE 1

Loose powder of ultrafine B₄C having an average particle size of less than about 70 nm is placed in a die and punch assembly (Model No. 3925, Carver, Inc., Wabash, Ind.) and pressed at 2960 atmospheres (300 MPa) to produce a powder compact with a green density greater than 60% of theoretical in the form of a cylindrical pellet 6.44 mm in diameter and 5 mm in height. The pellet is placed in a furnace that is then evacuated to a pressure of 0.001 atmospheres and heated to 1,400° C. at 10° C./min Helium is introduced and the pressure is increased to 10 atmospheres. The temperature is then ramped to 2,300° C. at 10° C./min and held at 2,300° C. for 1 hour. The furnace is allowed to cool to 2,000° C. and the pressure is then increased to 3,000 atmospheres and these conditions are held for 4 hours. The furnace is then allowed to cool to less than 100° C. and the densified pellet is removed.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

1. A method of consolidating ultrafine metal carbide or metal boride particles comprising the steps of:
providing a green body comprising the ultrafine metal carbide or metal boride particles;
sintering the green body at a sintering temperature and at an intermediate sintering pressure of from 2 atmospheres to less than 100 atmospheres; and
densifying the sintered green body after the sintering step at a high densification pressure above the intermediate sintering pressure.

2. The method of claim 1, wherein the intermediate sintering pressure is from 2 to 20 atmospheres.

3. The method of claim 1, wherein the intermediate sintering pressure is from 5 to 10 atmospheres.

4. The method of claim 1, wherein the sintering temperature is greater than 2,000° C.

5. The method of claim 1, further comprising the step of preheating the green body to a temperature less than 1,500° C. prior to the sintering step.

6. The method of claim 5, wherein the preheating step is performed under vacuum.

7. The method of claim 1, wherein the step of densifying is performed at an intermediate densification temperature below the sintering temperature.

8. The method of claim 7, wherein the intermediate densification temperature is from 1,500 to 2,100° C. and the high densification pressure is from 500 to 7,000 atmospheres.

9. The method of claim 1, wherein the ultrafine metal carbide or metal boride particles have an average particle size of less than 100 nm.

10. The method of claim 1, wherein the ultrafine metal carbide or metal boride particles have an average particle size of less than 50 nm.

11. The method of claim 1, wherein the ultrafine particles comprise boron carbide.

12. The method of claim 1, wherein the ultrafine metal carbide or metal boride particles are formed in a plasma.

13. The method of claim 1, wherein the green body further comprises at least one sintering aid, dopant or binder.

14. A consolidated metal carbide or metal boride product made by the method of claim 1.

15. A consolidated metal carbide or metal boride article comprising ultrafine metal carbide or metal boride particles produced by providing a green body comprising the ultrafine metal carbide or metal boride particles, sintering the green body at a sintering temperature and at an intermediate sintering pressure of from 2 atmospheres to less than 100 atmospheres, and densifying the sintered green body after the sintering step at a high densification pressure above the intermediate sintering pressure.

16. The method of claim 15, wherein the ultrafine metal carbide or metal boride particles have an average particle size of less than 100 nm.

17. The method of claim 15, wherein the ultrafine metal carbide or metal boride particles have an average particle size of less than 50 nm.

18. The method of claim 15, wherein the ultrafine particles comprise boron carbide.
